(19) United States
(12) Patent Application Publication
(10) Pub. No.: US 2022/0203564 A1
(43) Pub. Date: Jun. 30, 2022

(54) METHOD AND SYSTEM FOR WIRELESS MONITORING HAIR CUTTING APPARATUS

(71) Applicant: Daniel Santana, Tampa, FL (US)

(72) Inventor: Daniel Santana, Tampa, FL (US)

(21) Appl. No.: 17/139,626

(22) Filed: Dec. 31, 2020

(51) Int. Cl. B26B 19/38; H04W 24/10; H04W 4/38

(52) U.S. Cl. CPC B26B 19/388; H04W 4/38; H04W 24/10

(57) ABSTRACT

The present invention relates to a method and system for wirelessly monitoring and controlling hair cutting apparatus. Through the present method and system, it is possible to monitor the performance of hair cutting equipment, and control the hair cutting equipment, in order to maintain the overall condition of the hair cutting equipment and secure the equipment from unauthorized use.

The method of the present invention relates to connecting an electric board having specific sensor capabilities to the internal components of a hair cutting apparatus, and establishing a wireless connection between the modified hair cutting apparatus to a computing device having stored thereon a digital system that allows control and monitoring of the hair cutting apparatus.

### BACKGROUND

Hair cutting apparatus, such as clippers, generally include a housing that includes a singular or plurality of blades that are driven by an electric motor to allow the plurality of blades to oscillate from side to side or in a circular motion relative to one another to cut hair. Hair cutting apparatus and blow driers are subject to extreme conditions due to the high RPMs exhibited by the motor of hair cutting apparatus, their long term use, as well as the introduction of foreign elements, such as hair and dirt, into working components of the apparatus. Monitoring of hair cutting apparatus is thus vital, however, it is not possible to remotely monitor the performance of hair cutting apparatus. One can only check the current condition of apparatus via LCD screens located directly on the apparatus (when available).

In one example, the continual use of the apparatus results in increased temperature within the various parts of the hair cutting apparatus, and within the internal compartment of the apparatus. Increased temperature can result in breakdown of various lubricants that allow reduced friction by the apparatus parts. It would be beneficial to the industry to monitor, in real-time or in historical trend, the hair cutting apparatus in order to know when the apparatus is being degraded by high heat. Regular degradation reduces the lifespan of the apparatus or reduces its efficiency.

In order to allow the hair cutting apparatus to be monitored real-time, or collect and report on monitored data trends while avoiding intrusion on the use of the apparatus for cutting hair, performance data should be collected remotely and wirelessly.

### BRIEF DESCRIPTION

The present invention relates to a method and system for wirelessly monitoring and controlling hair cutting apparatus. Through the present method and system, it is possible to monitor the performance of hair cutting equipment, and control the hair cutting equipment, in order to maintain the overall condition of the hair cutting equipment and secure the equipment from unauthorized use.

The method of the present invention relates to connecting an electric board having specific sensor capabilities to the internal components of a hair cutting apparatus, and establishing a wireless connection between the modified hair cutting apparatus to a computing device having stored thereon a digital system that allows control and monitoring of the hair cutting apparatus. The system of the present invention includes a hair cutting apparatus that includes various sensors capable of collecting data on the performance and status of the hair cutting apparatus in real-time, whereby the collected data is wirelessly sent to a device having stored thereon computer related logic code and storage means that allows for storage and analysis of the collected stored, as well as alerting function when the collected data exceeds set performance ranges.

The method of the present invention also relates to controlling of the apparatus, such as locking and unlocking the apparatus, whereby unlocking allows the apparatus 300 to be operational, and locking stops operation of the apparatus 300. The digital system can also control lighting on the apparatus. The digital system can also remotely control speed of apparatus allowing on the fly management, instead of multiple preset speeds available on the apparatus itself (when available).

### DETAILED DESCRIPTION OF DRAWINGS

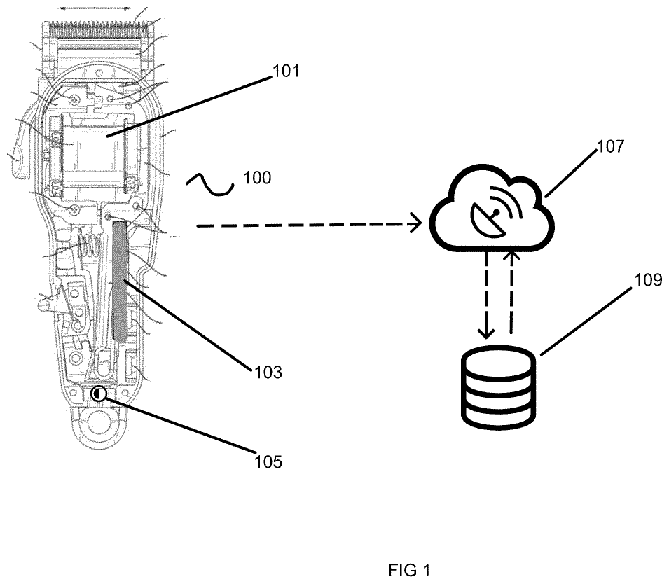

FIG. 1 is an embodiment of the present invention, whereby a hair cutting apparatus has presented thereon the means for collecting performance data and status of said hair cutting apparatus, whereby said collected performance data and status information is forwarded to a storage means;

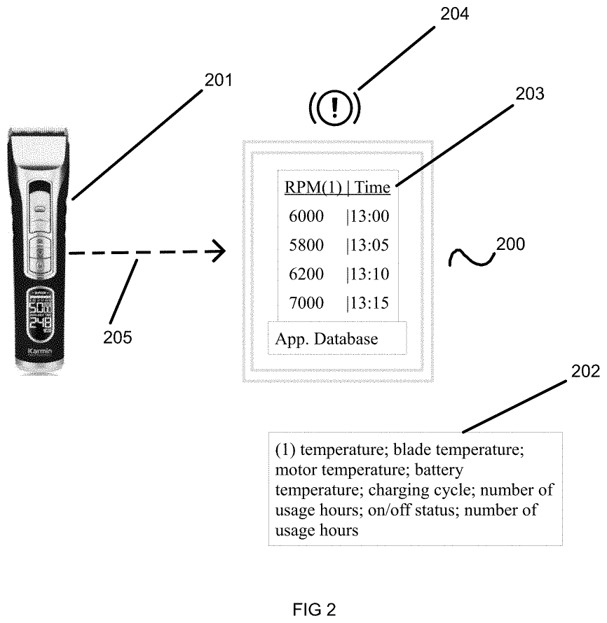

FIG. 2 is a further embodiment of the present invention, whereby a hair cutting apparatus possessing the monitoring means collects performance data of said hair cutting apparatus;

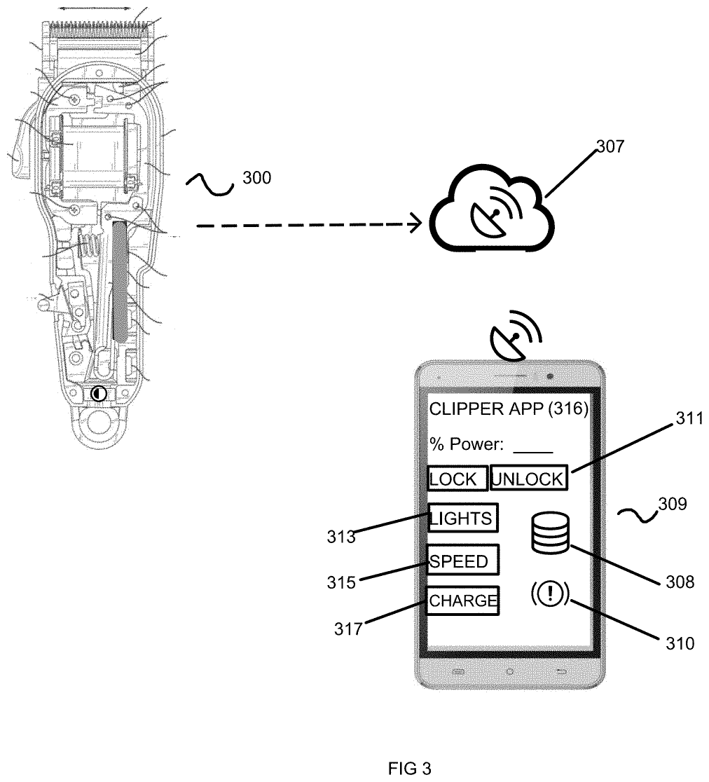

FIG. 3 is further embodiment of the present invention, whereby performance data is collected and forwarded to a device having a digital system for storing and analyzing said performance data. In addition, digital system enables the user to control the apparatus, example 315 can control the RPM of the motor in apparatus and 313 can control the lights;

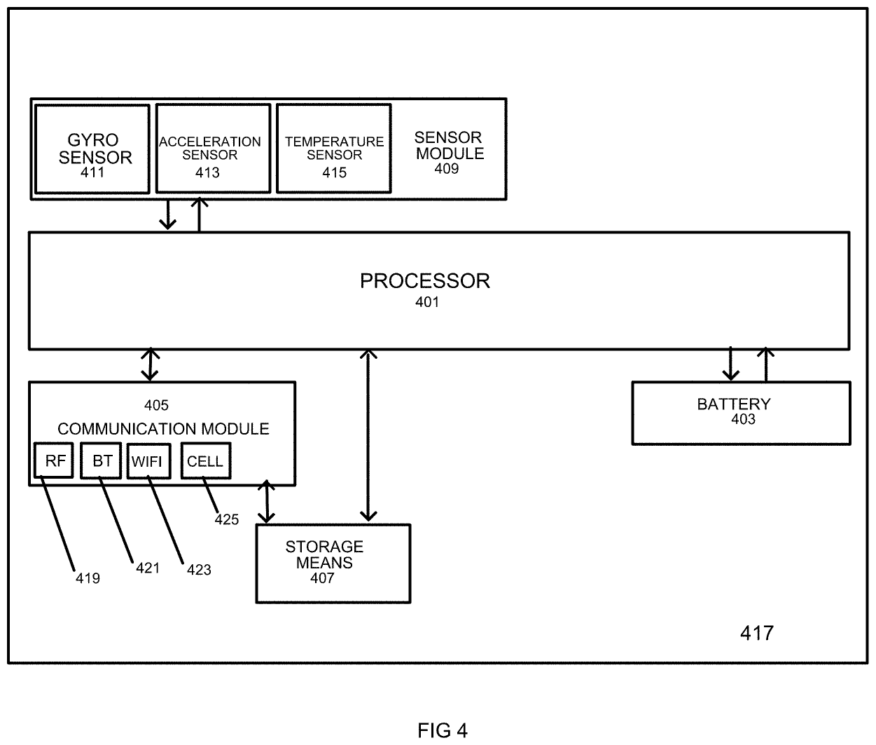

FIG. 4 is an embodiment of a means for providing a hair cutting apparatus the capabilities of having its performance data monitored, whereby said means is an electric board having stored thereon sensors.

### DETAILED DESCRIPTION

As used herein, “wireless” refers to a means for connecting between two or more systems without the requirement of a physical connector, for example a cord.

The following description includes descriptions and definitions to fully expand the related terms.

FIG. 1 is an embodiment of the present invention, whereby a hair cutting apparatus that possesses an electric board of the method and system, whereby the hair cutting apparatus, by way of the electric board, is in wireless communication with a data storage means.

Hair cutting apparatus 100 suitable for the present invention is wirelessly powered, meaning it has possessed therein a battery, rechargeable battery, or some other means for storing power suitable for driving the operation of the hair cutting apparatus. The Hair cutting apparatus 100 possesses a body 101 upon which generally sits a blade that operates in a known manner for such blades, i.e., either rotationally or vibrationally. The Hair cutting apparatus' body 101 wherein is housed the capability to turn electro-energy into mechanical energy that results in the means to groom hair. In such a wireless hair cutting apparatus 100 it possesses rechargeable batteries that deliver the electro-energy.

In the present invention, the hair cutting apparatus 100 includes therein an electric board 103, whereby the electric board 103 includes sensors capable of collecting data relating to the performance of the apparatus 100. As well known in the art, and to be described in more detail later, the electric board 103 can be a printed circuit board capable of accepting sensors attached thereto, generally via soldering and/or wirelessly connecting with sensors attached to parts. As the electric board 103 is inserted into the body 101 of the hair cutting apparatus 100, and the body 101 is of limited size, the electric board 103 is of a particular size. In addition to the size of the electric board 103 being specific to fit within the body 101 of the apparatus 100, the components (not shown) must be sized to fit within the electric board 103.

The components (not shown) suitable for inclusion on the board 103 are selected to collect performance data on the apparatus 100. The performance data of the apparatus 100 generally includes the internal temperature within the apparatus 100, the operating temperature of the blade of the hair cutting apparatus 100, the performance of the storage battery within the apparatus 100, energy consumption of the storage battery, charging cycle of the storage battery, operating blade speed, and the like. In one embodiment, the performance data is stored temporarily on a component of the board 103, prior to the data being sent to the permanent data 109 of the digital system.

Example components for use on the board 103 include thermistors, integrated circuit sensors (ICS), micro electrical mechanical systems (MEMS), accelerometers, vibration sensors, and the like. It is well-known in the art suitable types of sensor capable for use in the board 103 of the apparatus 100.

The apparatus 103 of the present invention further includes an operation light 105 that indicates the operational status of the hair cutting apparatus 100. The operation light 105 may be modifiable to the desires of the user, including setting the color exhibited by the light 105 and the intensity of the light.

During operation, the hair cutting apparatus 100 forwards timed performance data over a wireless network 107, such as from the protocols consisting of Zigbee protocol, wireless fidelity (WIFI), local access networks (LAN), personal access networks (PAN), wide area access network (WAN) and Bluetooth, NFC. Communication over the wireless network 107 occurs through a transmitter on the board 103 within the apparatus 100.

The performance data sent over the network 107 is stored on a database 109 of the digital system (not shown) of the present system. As further discussed below, the performance data can be organized on the external database into tabular format, for example SQL or MySQL format.

FIG. 2 is an embodiment of present invention, whereby performance data is sent wirelessly from the hair cutting apparatus, to be stored in tabular form on the database of the present system.

As stated above, during operation, performance data of the hair cutting apparatus 201 is sent 205 on a periodic basis to a database, whereby the performance data is stored in tabular form 203. By sending and storing performance data in tabular form 203 on a periodic basis, the data can be analyzed and indicate in real time when the hair cutting apparatus 201 performs outside of a set optimal range. When a determination of the hair cutting apparatus 201 operates outside of its optimal range, an alert 204 from the digital system can be sound.

FIG. 2 further lays out various performance data that can be sent and stored in tabular format, including temperature, blade temperature, motor temperature, battery temperature, charging cycle, number of usage hours, on/off status, number of usage hours, and the like.

FIG. 3 is an embodiment of the present invention, including a hair cutting apparatus 300, wireless network 307, a computing device 309 having stored thereon a digital system 316, wherein the digital system 316 includes memory storage.

The hair cutting apparatus 300 is as described above, wherein a board (not shown) having stored thereon a variety of sensors for monitoring the performance of the hair cutting apparatus. Communicating over a wireless network 307 (as described above), analysis and usage of the performance data is performed on a computing device 309. Suitable computing devices 309 include a remote control, laptop computer, a mobile device such as a mobile phone, a desktop computer, or tablet computer. As is well-known in the art, such computing devices can include monitors/screens for exhibiting user interface, processor, sound and sound card, storage means, and means for wireless communication over a network.

The present invention includes a digital system stored on the storage means of the computing device 309. The digital system 316, also known as a “Clipper App”, includes computer code for analyzing the performance data sent from the hair cutting apparatus 300. The digital system 316 includes code for allowing control of the apparatus 300, such as locking and unlocking the apparatus 300, whereby unlocking allows the apparatus 300 to be operational, and locking stops operation of the apparatus 300. The digital system 316 can also control lighting on the apparatus 300, and monitor aspects of the apparatus such as performance speed 315 of the apparatus blade movement, and the (battery) charge 317 of the apparatus.

The storage means 308 within the device 309 includes a means of organizing performance data, preferably in tabular format. As stated above, the tabular format allows real-time monitoring of the performance data. A user can set a preferred range of operation of the device, for example a preferred temperature of the internal atmosphere of the apparatus 300. If the internal temperature goes outside of a preferred range of +/−15%, or user defined via the “clipper app”, the digital system 316 can activate an audible and/or visual alert 310, the digital system can be configured to shut off the apparatus for safety purpose. Upon being alerted, a user can decide to ‘shut down’ the apparatus to allow a cooling-off period.

FIG. 4 is an embodiment of an electric board 417 of the present invention, whereby the electric board can be a printed circuit board. The electric board 417 generally includes a processor 401 for handling the collection of performance data (not shown), whereby the performance data is obtained via a sensor module 409. The sensor module 409 can include sub-components, for example gyro sensors 411, accelerometer 413, temperature sensor(s) 415, and other sub-components that relate to the operation of the hair cutting apparatus. A communication module 405 is further included on the electric board 417, whereby the communication module 405 is used for sending the performance data to the remote digital system (not shown) of the invention. Stored on the communication module 405 can include sub-components, for example radio frequency 419, bluetooth 421, wireless fidelity 423, cellular means 425 and NFC or other wireless communication protocol or technology.

A battery 403, preferably a rechargeable battery, is used to drive the various components of the electric board 417.

I claim:

1. A method for monitoring and controlling a hair cutting apparatus, comprising the steps of:
collecting performance data relating to said hair cutting apparatus;
sending said performance data over a wireless network to a storage means;
organizing said performance data in tabular form on said storage means;
analyzing said stored performance data on a computing device;
calculating a performance range of said performance data; and
based upon said calculated performance range, controlling the operation of said hair cutting apparatus.

2. The method of monitoring and controlling said hair cutting apparatus of claim 1, wherein collecting said performance data is performed through the use of one or more sensors selected from the group consisting of integrated circuit sensors, micro electrical mechanical systems, accelerometers, vibration sensors, and thermistors, wherein said sensors are stored on said hair cutting apparatus.

3. The method of monitoring and controlling said hair cutting apparatus of claim 2, wherein said performance data includes one or more data selected from the group consisting of internal temperature within said apparatus, operating temperature of a blade of said hair cutting apparatus, performance of a storage battery within said hair cutting apparatus, energy consumption of a storage battery, charging cycle of a storage battery, and operating speed of a blade.

4. The method of monitoring and controlling said hair cutting apparatus of claim 1, wherein sending said performance data over a wireless network to a storage means comprises sending performance data over protocol selected from the group consisting of Zigbee protocol, wireless fidelity, local access network, personal access network, wide area access network, Bluetooth, and NFC.

5. The method of monitoring and controlling said hair cutting apparatus of claim 4, wherein sending over said protocol occurs through the use of a wireless transmitter stored on said hair cutting apparatus.

6. The method of monitoring and controlling said hair cutting apparatus of claim 1, whereby organizing said performance data in tabular format further comprises organizing the performance data based upon data and time collected.

7. The method of monitoring and controlling said hair cutting apparatus of claim 6, whereby said tabular format is stored on a remote database selected from one of SQL, NoSql, and MySQL.

8. The method of monitoring and controlling said hair cutting apparatus of claim 1, whereby analyzing said stored performance data on a computing device comprises real-time calculation of the change of said performance data over time (Δ(performance data)/Time).

9. The method of monitoring and controlling said hair cutting apparatus of claim 8, whereby said computing device is selected from the group consisting of a mobile phone, tablet, laptop computer, smart watch, and desktop computer.

10. The method of monitoring and controlling said hair cutting apparatus of claim 9, further comprising the step, prior to controlling the operation of said hair cutting apparatus, an alert is emitted from said computing device.

11. The method of monitoring and controlling said hair cutting apparatus of claim 10, wherein said emitted alert is an audible alert.

12. The method of monitoring and controlling said hair cutting apparatus of claim 10, whereby controlling the operation of said hair cutting apparatus includes the steps of decreasing the RPM of said blade, or turning off said hair cutting apparatus.

13. The method of monitoring and controlling said hair cutting apparatus of claim 8, wherein when said change of said performance data over time exceeds an established range, an alert is executed.

14. A system for wirelessly monitoring and controlling a hair cutting apparatus, comprising
a hair cutting apparatus including a board having at one least sensors stored thereon, wherein said board is positioned inside the body of said apparatus;
a remote network for transmitting data collected from said sensors to a remote database;
a computing device for analyzing said data, whereby said computing device controls said hair cutting apparatus; and
a digital system stored on said computing device, whereby said digital system is capable of accessing said data, analyzing said data, and controlling said hair cutting apparatus
wherein said data is performance data of said hair cutting apparatus, said performance data including at least of internal temperature within said apparatus, operating temperature of a blade of said hair cutting apparatus, performance of a storage battery within said hair cutting apparatus, energy consumption of a storage battery, charging cycle of a storage battery, and operating speed of a blade.

15. The system for wirelessly monitoring and controlling a hair cutting apparatus of claim 13, wherein said board is a printed circuit board including thereon at least one sensor selected from the group consisting of integrated circuit sensors, micro electrical mechanical systems, accelerometers, vibration sensors, and thermistors.

16. The system for wirelessly monitoring and controlling a hair cutting apparatus of claim 13, further comprising a transmitter.

17. The system for wirelessly monitoring and controlling a hair cutting apparatus of claim 13, wherein said computing device is selected from the group consisting of mobile device, laptop, tablet, and desktop.

18. The system for wirelessly monitoring and controlling a hair cutting apparatus of claim 13, wherein said digital system includes the ability to analyze said performance data over time and an alert system.
